(19) United States
(12) Patent Application Publication
(10) Pub. No.: US 2018/0300765 A1
(43) Pub. Date: Oct. 18, 2018

(54) Method for Publicizing Musical Artists and Promoting New Musical Works

(71) Applicant: Chanku Sim, Orlando, FL (US)

(72) Inventor: Chanku Sim, Orlando, FL (US)

(21) Appl. No.: 15/954,549

(22) Filed: Apr. 16, 2018

Related U.S. Application Data
(60) Provisional application No. 62/485,516, filed on Apr. 14, 2017.

(51) Int. Cl. G06Q 30/02; G06Q 50/00; G07C 13/00

(52) U.S. Cl. CPC G06Q 30/0269; G06F 17/30772; G07C 13/00; G06Q 50/01

(57) ABSTRACT

A method and system for publicizing musical artists and promoting new musical works implements a blind vote, whereby users objectively judge and vote on a plurality of anonymous musical entries to determine a winning musical entry. The system employs a plurality of user accounts managed by at least one remote server, wherein each user account is associated to a corresponding personal computing (PC) device. The method enables a plurality of contestant accounts to enter a musical competition, wherein the plurality of contestant accounts is designated from the plurality of user accounts. Each of the plurality of musical entries is converted into an anonymous musical entry. The remote server then prompts each user account to listen to and vote on each anonymous musical entry. Thereafter, the remote server receives a vote count for each anonymous musical entry and sharing a most-popular entry on the social networking link for each contestant account through the remote server.

The current application claims a priority to the U.S. Provisional Patent application Ser. No. 62/485,516 filed on Apr. 14, 2017. The current application is filed on Apr. 16, 2017 while Apr. 14, 2017 was on a weekend.

### FIELD OF THE INVENTION

The present invention generally relates to a method and system for publicizing musical artists and promoting new musical works. More specifically, a blind vote is implemented to judge a plurality of anonymous musical entries and prevent subjective factors from influencing the voters' decision.

### BACKGROUND OF THE INVENTION

There are large numbers of unknown artists who are struggling to introduce their music through social networking site (SNS), YouTube, or performing in public. The present popularity-based method of sharing and promoting music does not aid the discovery of new artists. Despite the many avenues of sharing and promoting music enabled by the internet, most internet-based media outlets give disproportionate exposure to a small number of songs by the same artists. As such, many listeners are tired of having to listen to same songs by the same artists.

However, many listeners are also unwilling to give new artists a chance. Listeners often have preconceived opinions on certain types of music or the background of the artists. Oftentimes, listeners judge music on subjective factors that do not concern the quality of the music itself. For example, the music is usually judged by the album cover, the musician's background, the specific genre of the music, or several other factors that are completely unrelated to the quality of the music. Thus, it is very difficult for new artists to overcome preexisting biases and have their music judged on its merits.

The present invention provides a means for artists to upload their songs anonymously, where they can achieve popularity based on the quality of their product as opposed to having the right name or reputation. Further, the present invention provides a means for the listeners to discover new music or art and subsequently play a role in promoting, and thus popularizing, new artists.

As such, the present invention is a method and system for increasing public exposure to new music, whereby artists can upload their musical work, especially music. The musical work receives a random title and is made available to users, whether they be listeners or viewers. The users vote on the musical work and votes are tabulated. The artist who receives the most support is revealed and published on the social media accounts of the other competing artists. This allows users to experience and play a part in promoting new music, and gives support to artists who need support to continue to produce art.

### BRIEF DESCRIPTION OF THE DRAWINGS

FIG. 1A is a schematic illustrating the connections between the plurality of PC device and the one remote server.

FIG. 1B is a block diagram illustrating the system implemented by the method of the present invention.

FIG. 2 is a flowchart of the overall process for the method of the present invention.

FIG. 3 is a flowchart of a subprocess of giving the musical entry a genuine title.

FIG. 4 is a flowchart of a subprocess of arranging the plurality of anonymous entries into a randomized playlist.

FIG. 5 is a flowchart of a subprocess of playing the anonymous entries in the randomized playlist sequentially.

FIG. 6 is a flowchart of a subprocess of giving the user the option of skipping a current entry, after a mandatory listening-time limit has passed.

FIG. 7 is a flowchart of a subprocess of managing a submission time period by the remote server.

FIG. 8 is a flowchart of a subprocess of generating interactive instructions with the remote server for the most-popular entry.

FIG. 9 is a flowchart of a subprocess sending the most-popular entry to the social networking link for each contestant account.

FIG. 10 is a flowchart of a subprocess of prompting each user account to share the most-popular entry to the corresponding social networking profile.

### DETAILED DESCRIPTION OF THE INVENTION

All illustrations of the drawings are for the purpose of describing selected versions of the present invention and are not intended to limit the scope of the present invention.

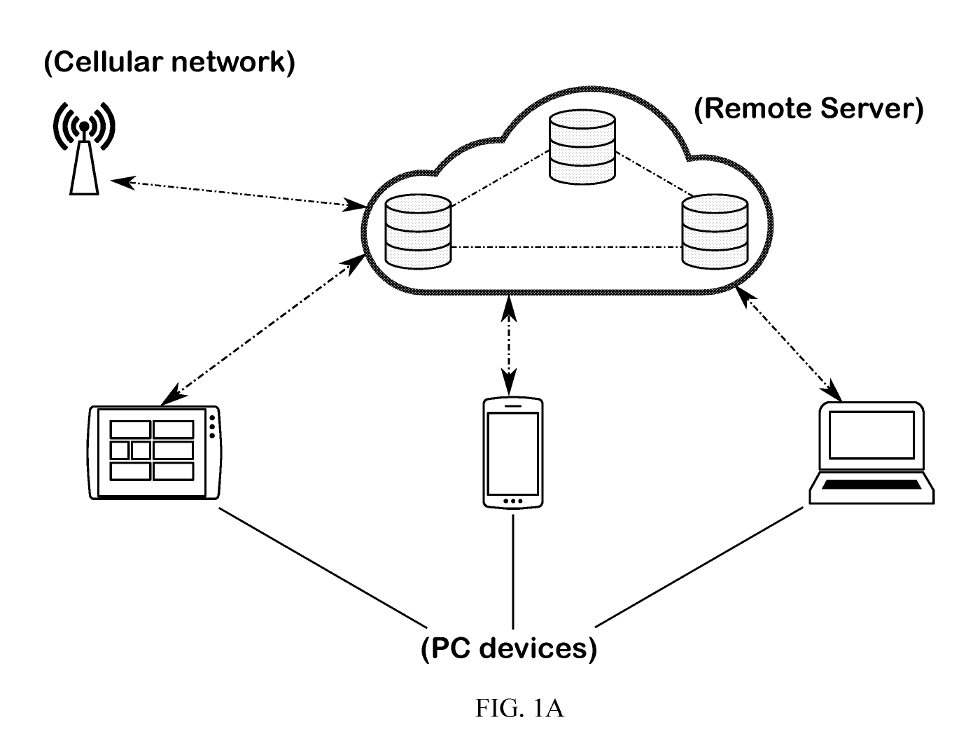

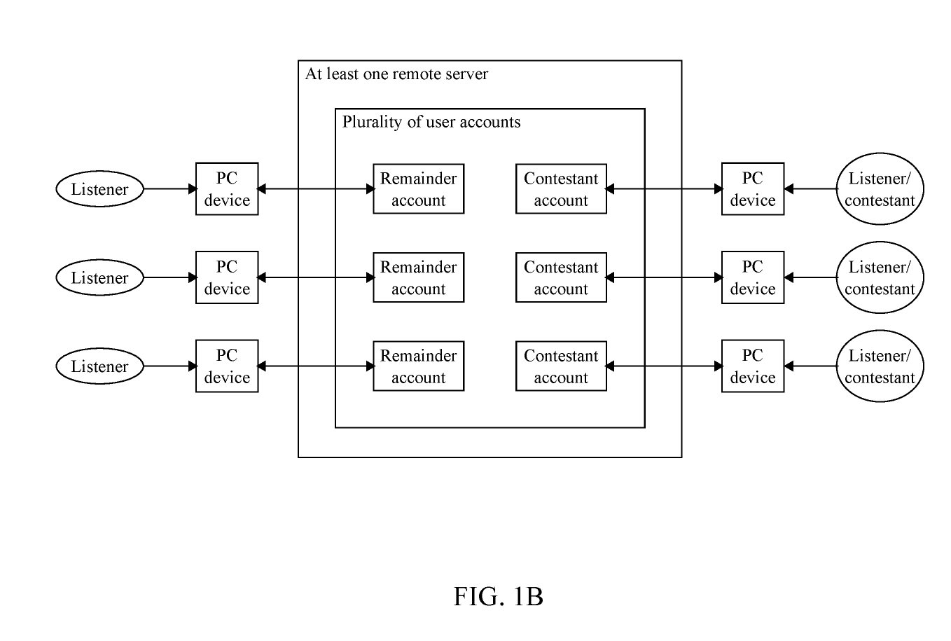

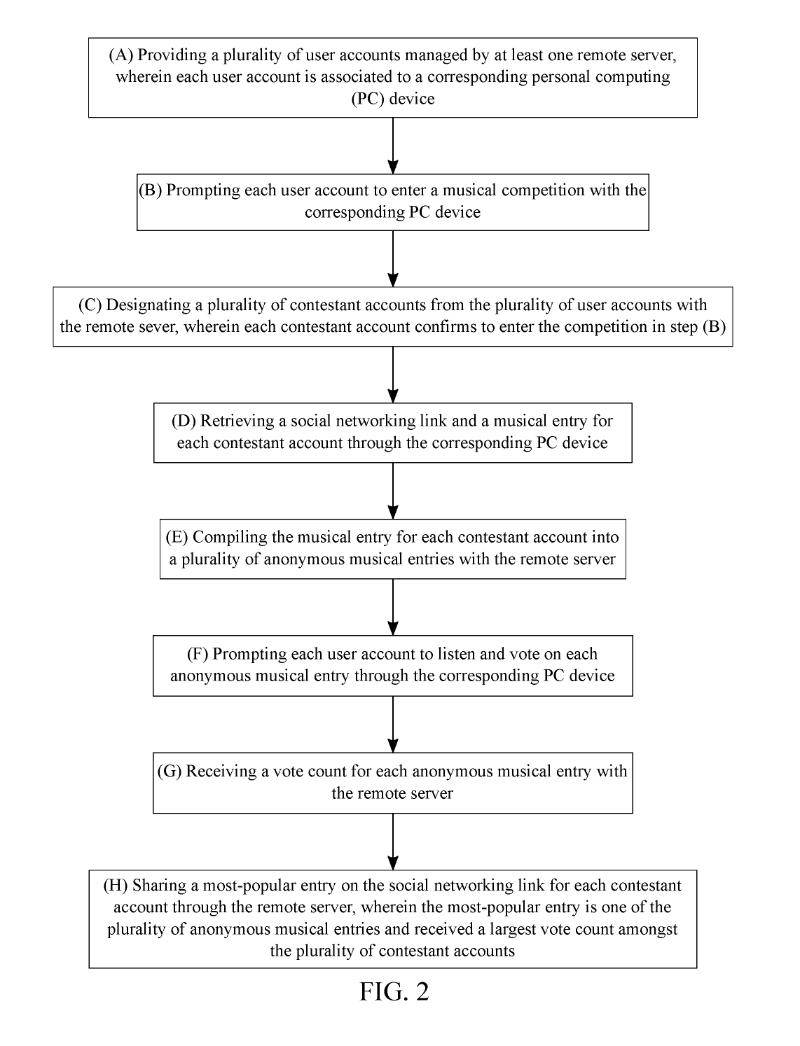

Referring to FIG. 1 and FIG. 2, the present invention is a method and system for publicizing musical artists and promoting new musical works in an anonymized fashion. The system includes a non-transitory computer readable medium for storing the method and at least one processor for executing the method. Embodiments of the present invention may utilize a computer readable medium distributed between several computing systems and a plurality of processors capable of executing a portion of the method. The system of the present invention provides a plurality of user accounts managed by at least one remote server, wherein each user account is associated to a corresponding personal computing (PC) device. In the preferred embodiment, the plurality of user accounts is stored and managed within the remote server (Step A). Alternately, the plurality of user accounts may be distributed between a plurality of remote servers internetworked together. The corresponding PC device allows a user to access the remote server and set up a user account. The corresponding PC device is preferably a client computing device such as a desktop, laptop, smartphone, tablet, personal digital assistant (PDA) and/or the like. Preferably, the corresponding PC device is wirelessly connected to the remote server via a cellular, cable, or fiberoptic network.

To set up the user account, the user must provide identifying credentials such as a password and a username, that prevent unauthorized access to the user account. Once the user account is established, the user can upload, download, share, and promote musical works. Preferably, the user may upload a plurality of musical works into the user account via the corresponding PC device. As such, the plurality of user accounts is networked together by the remote server to allow users to share and promote the plurality of musical works amongst each other. In the preferred embodiment, the plurality of musical works may be stored in a shared database in the remote server. The shared database allows an arbitrary user account to search for and access musical works contributed by another user account. Each musical work is preferably given a title, an artist name, a running-length, and a genre. As such, the plurality of user accounts can filter the plurality of musical works may by title, genre, or artist to find the desired musical work. Further, the plurality of user accounts comprises a like option whereby users can like and/or recommend their favorite musical works. This also allows the remote server to create a voting framework whereby musical works are ranked based on the number of likes given by unique users. Further, the musical works may be anonymized to prevent biased or prejudiced choices.

Referring most specifically to FIG. 2, accordingly, the corresponding PC device prompts each user account to enter a musical competition (Step B). The prompt may be in the form of a notification displayed on the corresponding PC device when the user logs into the user account. If the user agrees to enter the musical competition, the user account is designated as a contestant account by the remote server. As such, the remote server designates a plurality of contestant accounts from the plurality of user accounts, wherein each contestant account confirms to enter the musical competition in Step B (Step C). More specifically, the plurality of user accounts may need to go through a contestant registration process to be designated as the plurality of contestant accounts. Hereinafter, a contestant refers to the user who is participating in the musical competition, whereas a listener refers to users who listen, judge, and vote on the musical entries. Since, the contestant is also given the ability to vote, the contestant is also counted as the listener. As part of the contestant registration process, the contestant must agree to share the winning musical work on their social networking accounts to help the winning contestant gain publicity and exposure. As such, the corresponding PC device retrieves a social networking link and a musical entry for each contestant account through the corresponding PC device (Step D). The musical entry refers to a musical work submitted to the competition. The musical entry may be a musical work that has already been uploaded into the remote server or may be a musical work uploaded specifically for the musical competition. The social networking link may be a URL for the contestant's social networking account, which given the remote server the ability to post links on the contestant's social networking profile.

The remote server uses the social networking link to access the social networking profile of the contestant and post the winner of the musical competition. Preferably, both the social networking link and the musical entry are both uploaded into the remote server through the corresponding PC device. Thereafter, the remote server is responsible for distributing the musical entry amongst the plurality of user accounts as well as the social networking profiles of the contestants. As such, the remote server compiles the musical entry for each contestant account into a plurality of anonymous musical entries with the remote server (Step E). The anonymous musical entry lacks any attribute which may disclose the artist, genre, album, or theme of the musical entry. This prevents listeners from subjectively judging the musical entry and encourages them to judge the musical quality of the musical entry instead.

Once the plurality of anonymous musical entries is compiled, the remote server distributes each anonymous musical entry to each of the plurality of user accounts. More specifically, the corresponding PC device prompts each user account to listen and vote on each anonymous musical entry (Step F). In the preferred embodiment, the plurality of contestant accounts is also prompted to listen and vote on each anonymous entry. Both contestants and listeners may have the option to listen to the playlist when they login to the user account or contestant account. Listeners also have the option through the present invention to like one or more of the plurality of anonymous musical entries as they are listening to the playlist. As such, the remote server receives a vote count for each anonymous musical entry (Step G). This information is sent to the remote servers to determine the winner of the musical competition. Accordingly, the remote server shares a most-popular entry on the social networking link for each contestant account, wherein the most-popular entry is one of the plurality of anonymous musical entries and received a largest vote count amongst the plurality of contestant accounts (Step H). Preferably, the most-popular entry is automatically shared to the social networking link for each contestant account. This helps the contestant who made the most-popular entry gain public exposure on the merit of the music and not on subjective factors which are not related to music.

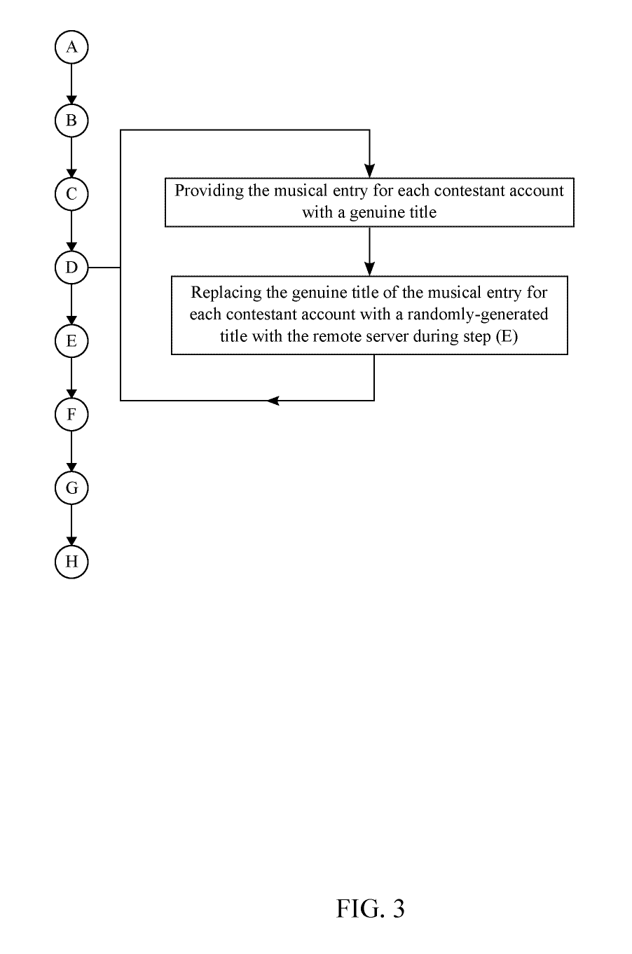

Referring to FIG. 3, similarly, the musical entry for each contestant account is also provided with a genuine title. The genuine title is the title of the musical work associated with the musical entry. The remote server uses the genuine title to keep track of the musical entry and correctly identify the contributing contestant. Once the most-popular entry is determined, the remote server shares the genuine title, along with the artist name, genre, album name, album cover, and like identifying attributes to the social networking link of each user account. To convert the musical entry into the anonymous musical entry, the genuine title of the musical entry for each contestant account is replaced with a randomly-generated title with the remote server during Step E. More specifically, a random-word generator permutates a list of words to generate a unique randomly-generated title for each anonymous musical entry. As such, the anonymous musical entry is identified solely by the randomly-generated title which gives no indication of the artist name, genre, and theme. This forces listeners to judge the anonymous musical entry solely on the quality of the music and not on subjective factors associated to the artist or genre.

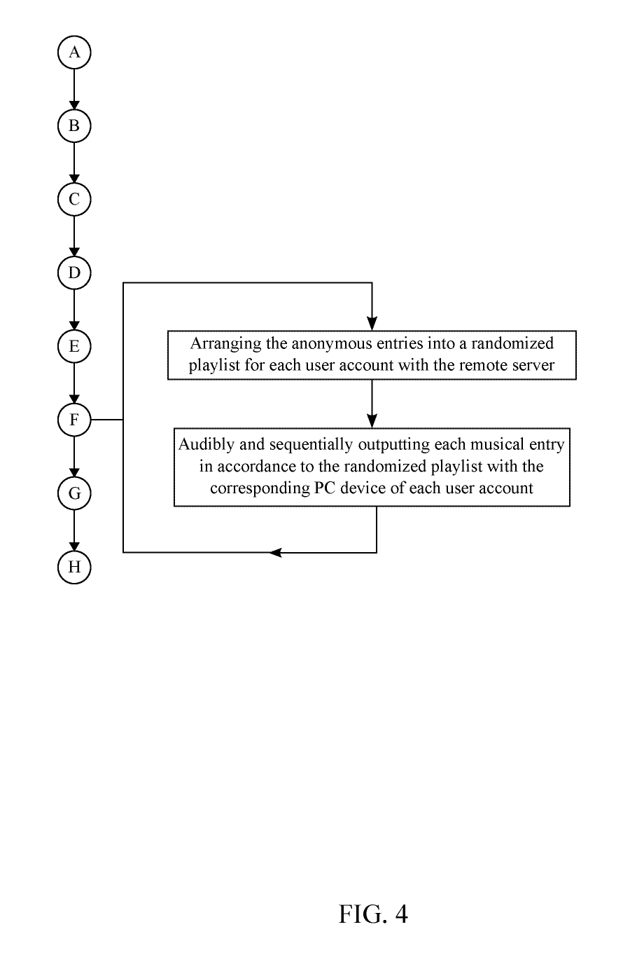

Referring to FIG. 4, preferably, the plurality of anonymous musical entries is arranged into a randomized playlist for each user account with the remote server. As such, the remote server shares the randomized playlist to plurality of user accounts. Preferably, the listeners listen to the randomized playlist through the PC device. As such, each anonymous musical entry is audibly and sequentially outputted with the corresponding PC device of each user account, in accordance to the randomized playlist. Although the plurality of anonymous musical entries is arranged in no particular order, the randomized playlist sequentially plays each anonymous musical entry from the beginning to the end to ensure each anonymous musical entry is played at least once. However, since the randomized playlist may contain a hundred or so anonymous musical entries, the listeners are also allowed to skip through the playlist. Therefore, a mandatory-listening time limit managed by the remote server is provided. The mandatory-listening time limit helps listeners quickly progress through the randomized playlist while ensuring that the listeners listen to all the anonymous musical entries in the randomized playlist.

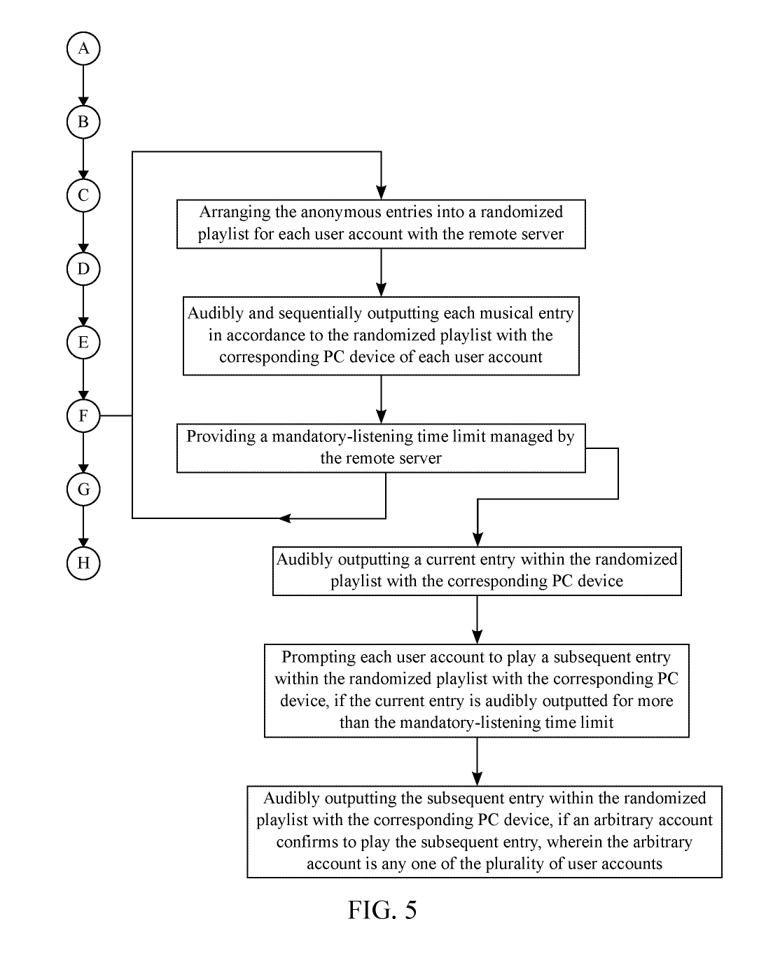

Referring to FIG. 5, in the preferred embodiment, the corresponding PC device audibly outputs a current entry within the randomized playlist. The current entry is the anonymous musical entry being audibly outputted as the listener progresses through the randomized playlist. The listener must listen to the current entry for the mandatory-listening time limit before moving on to a succeeding or preceding anonymous musical entry. As such, the corresponding PC device prompts each user account to play a subsequent entry within the randomized playlist, if the current entry is audibly outputted for more than the mandatory-listening time limit. Listeners can choose through the present invention to skip to the subsequent entry or continue listening to the current entry. The corresponding PC device audibly outputs the subsequent entry within the randomized playlist if an arbitrary account confirms to play the subsequent entry, wherein the arbitrary account is any one of the plurality of user accounts. Each user account is given the option to play the subsequent entry once the mandatory-listening time limit passes, however the arbitrary account refers to only those user accounts that choose to play the subsequent entry. Since each user account is given a unique randomized playlist, the arbitrary account interacts with the random account independent of the other user accounts. For example, while the arbitrary account may progress rapidly through the randomized playlist, another arbitrary account may vote for the anonymous musical entry and never finish the randomized playlist.

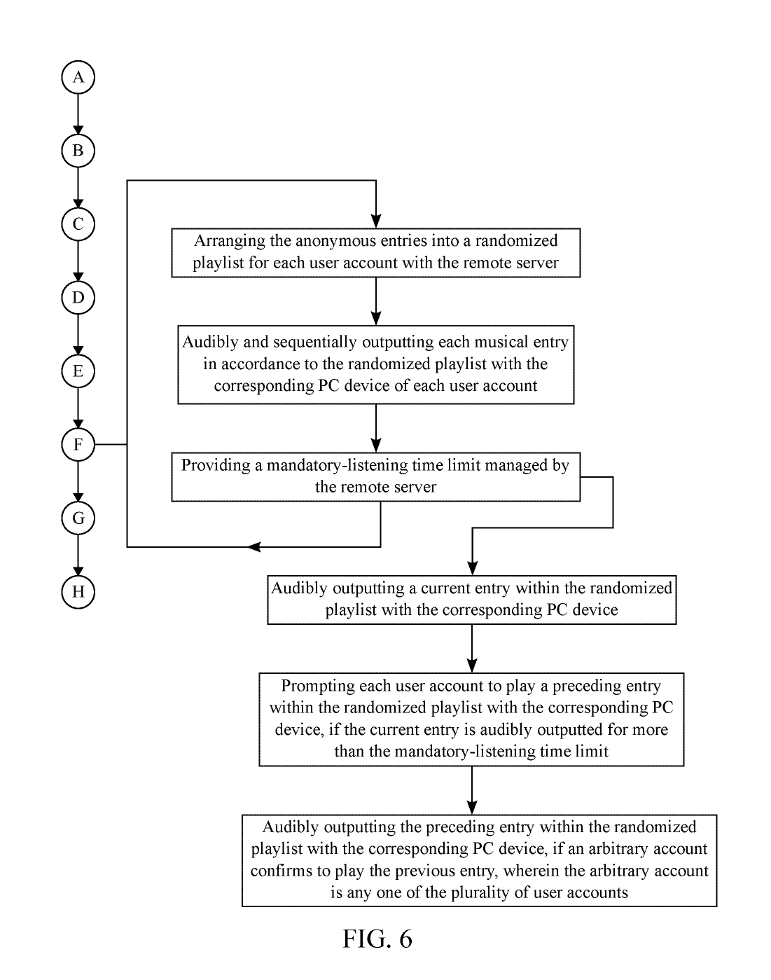

Referring to FIG. 6, the corresponding PC device also prompts each user account to play a preceding entry within the randomized playlist, if the current entry is audibly outputted for more than the mandatory-listening time limit. As such, the corresponding PC device audibly outputs the preceding entry within the randomized playlist, if an arbitrary account confirms to play the previous entry, wherein the arbitrary account is any one of the plurality of user accounts. Further, if the arbitrary account finishes listening to all of the anonymous musical entries in the randomized playlist, an arbitrarily chosen anonymous musical entry can be played. This allows listeners to jump around in the randomized playlist to listen to their favorite entries.

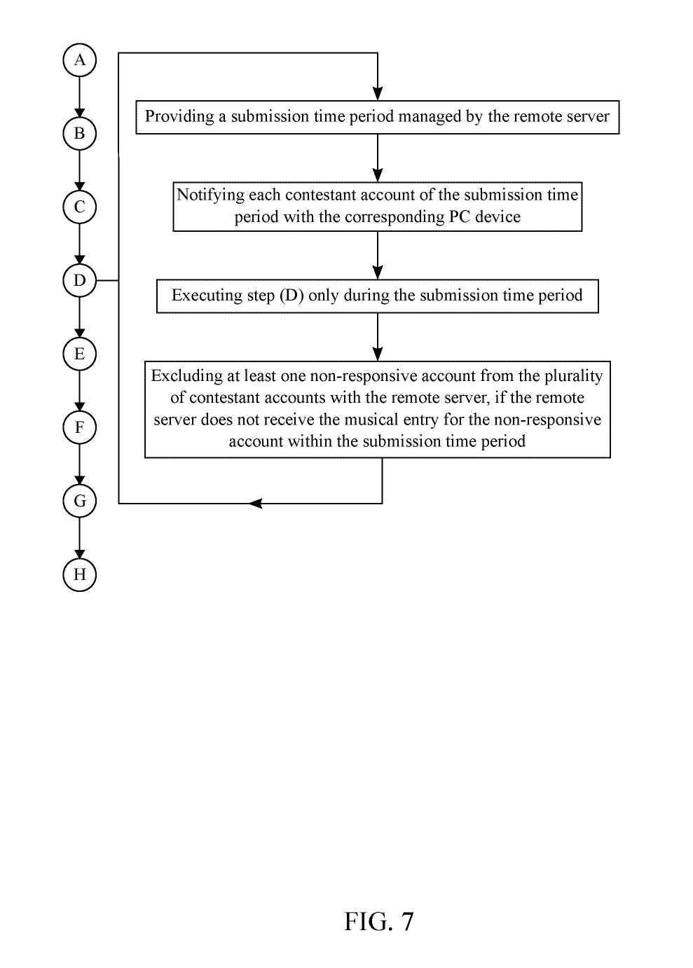

Referring to FIG. 7, in the preferred embodiment, the voting on the plurality of anonymous musical entries starts after all of the plurality of anonymous musical entries is submitted. As such, a submission time period managed by the remote server is provided. In the preferred embodiment, the submission time period may begin simultaneously with the registration process. Alternately, the submission time period may begin after the user accounts have registered as the contestant accounts. In both cases, each contestant account is notified of the submission time period with the corresponding PC device. The contestant account must submit the musical entry and the social networking link the within the submission time period. Thus, Step D executes only during the submission time period. Further, the remote server excludes at least one non-responsive account from the plurality of contestant accounts, if the remote server does not receive the musical entry for the non-responsive account within the submission time period. The at least one non-responsive account refers to the contestant account that fails to upload the musical work into the remote server within the submission time period. As such, the non-responsive account and the associated contestant is disqualified from the musical competition.

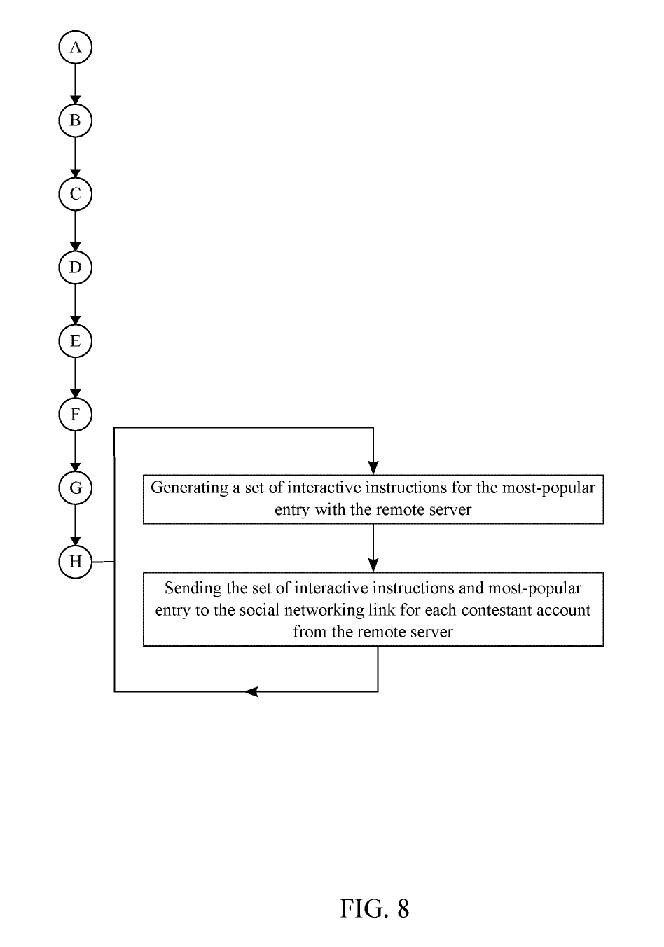

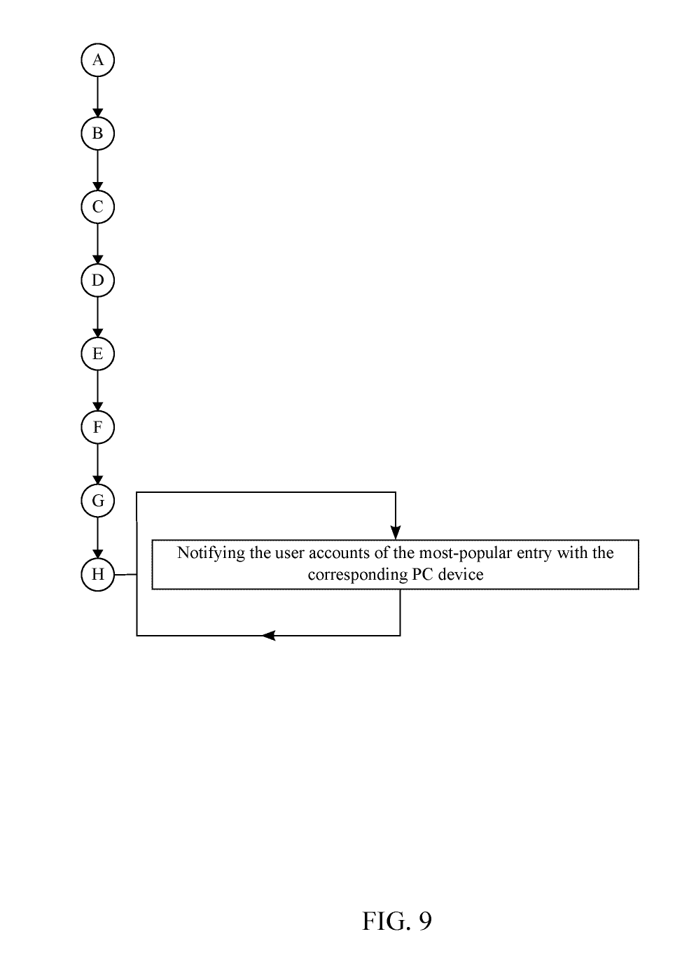

Referring to FIG. 8 and FIG. 9, in the preferred embodiment, the remote server uses the social networking link from each user account to share the most-popular entry to social networking profile of each of the contestants. More specifically, the remote server may generate a set of interactive instructions for the most-popular entry. Preferably, the set of interactive instructions may be a link and a media file of the musical work that was chosen as the most-popular entry. The link may direct to a page that displays the most-popular entry along with the other musical works by the winning contestant. The media file may feature the audio of the musical work and a customized background illustrating the album cover or the logo for the musical competition. The remote server sends the set of interactive instructions and most-popular entry to the social networking link for each contestant account. The media file may be played through the proprietary video or audio player of the social networking profile.

To further increase exposure of the winning contestant, the plurality of user accounts is notified of the result of the competition. More specifically, the user accounts are notified of the most-popular entry with the corresponding PC device. The notification may have the genuine title, artist name, album name, album cover, as well as an audio file of the musical work chosen as the most-popular entry.

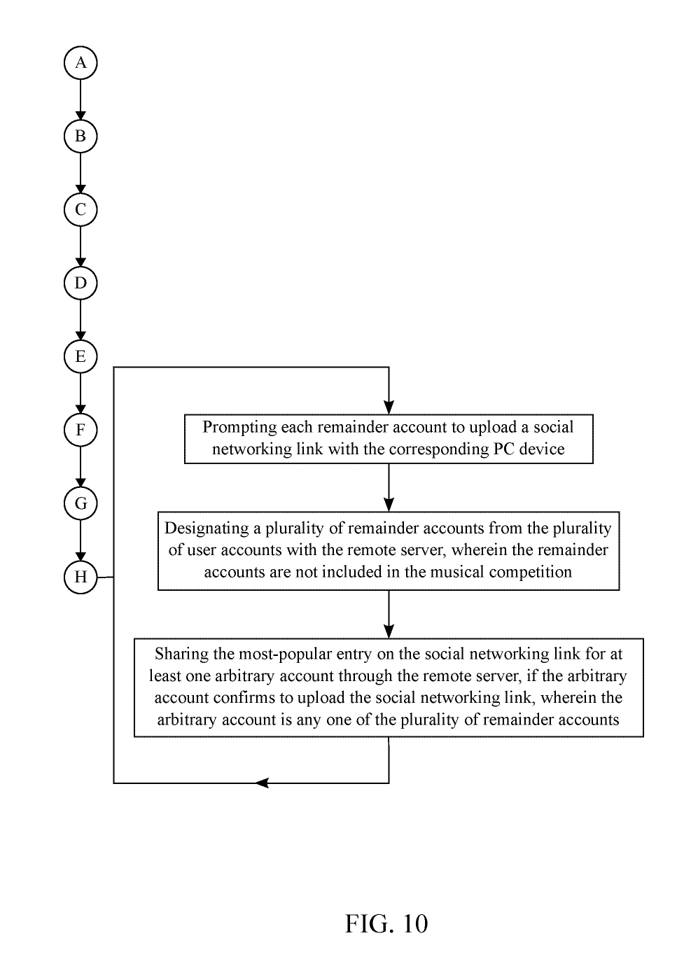

Referring to FIG. 10, further, the listeners that abstained from the musical competition can also share their social networking profiles. In the preferred embodiment, the remote server designates the plurality of remainder accounts from the plurality of user accounts, wherein the remainder accounts are not included in the musical competition. Although the plurality of remainder accounts is not included in the musical competition, the plurality of remainder accounts may share the most-popular entry to a corresponding social networking profile. To do so, each remainder account is prompted to upload a social networking link with the corresponding PC device. The remote server shares the most-popular entry on the social networking link for at least one arbitrary account, if the arbitrary account confirms to upload the social networking link, wherein the arbitrary account is any one of the plurality of remainder accounts. As such, the arbitrary account provides the remote server with the social networking link, whereby the remote server accesses the user's social networking profile and posts the most-popular entry.

Although the invention has been explained in relation to its preferred embodiment, it is to be understood that many other possible modifications and variations can be made without departing from the spirit and scope of the invention as hereinafter claimed.

What is claimed is:

1. A method for publicizing musical artists and promoting new musical works comprises the steps of:
(A) providing a plurality of user accounts managed by at least one remote server, wherein each user account is associated to a corresponding personal computing (PC) device;
(B) prompting each user account to enter a musical competition with the corresponding PC device;
(C) designating a plurality of contestant accounts from the plurality of user accounts with the remote sever, wherein each contestant account confirms to enter the musical competition in step (B);
(D) retrieving a social networking link and a musical entry for each contestant account through the corresponding PC device;
(E) compiling the musical entry for each contestant account into a plurality of anonymous musical entries with the remote server;
(F) prompting each user account to listen and vote on each anonymous musical entry through the corresponding PC device;
(G)receiving a vote count for each anonymous musical entry with the remote server; and
(H) sharing a most-popular entry on the social networking link for each contestant account through the remote server, wherein the most-popular entry is one of the plurality of anonymous musical entries and received a largest vote count amongst the plurality of contestant accounts.

2. The method for publicizing musical artists and promoting new musical works as claimed in claim 1 comprises the steps of:
providing the musical entry for each contestant account with a genuine title; and
replacing the genuine title of the musical entry for each contestant account with a randomly-generated title with the remote server during step (E).

3. The method for publicizing musical artists and promoting new musical works as claimed in claim 1 comprises the steps of:
arranging the anonymous musical entries into a randomized playlist for each user account with the remote server; and
audibly and sequentially outputting each musical entry in accordance to the randomized playlist with the corresponding PC device of each user account.

4. The method for publicizing musical artists and promoting new musical works as claimed in claim 3 comprises the steps of:
providing a mandatory-listening time limit managed by the remote server;
audibly outputting a current entry within the randomized playlist with the corresponding PC device;
prompting each user account to play a subsequent entry within the randomized playlist with the corresponding PC device, if the current entry is audibly outputted for more than the mandatory-listening time limit; and
audibly outputting the subsequent entry within the randomized playlist with the corresponding PC device, if an arbitrary account confirms to play the subsequent entry, wherein the arbitrary account is any one of the plurality of user accounts.

5. The method for publicizing musical artists and promoting new musical works as claimed in claim 3 comprises the steps of:
providing a mandatory-listening time limit managed by the remote server;
audibly outputting a current entry within the randomized playlist with the corresponding PC device;
prompting each user account to play a preceding entry within the randomized playlist with the corresponding PC device, if the current entry is audibly outputted for more than the mandatory-listening time limit; and
audibly outputting the preceding entry within the randomized playlist with the corresponding PC device, if an arbitrary account confirms to play the previous entry, wherein the arbitrary account is any one of the plurality of user accounts.

6. The method for publicizing musical artists and promoting new musical works as claimed in claim 1 comprises the steps of:
providing a submission time period managed by the remote server;
notifying each contestant account of the submission time period with the corresponding PC device;
executing step (D) only during the submission time period; and
excluding at least one non-responsive account from the plurality of contestant accounts with the remote server, if the remote server does not receive the musical entry for the non-responsive account within the submission time period.

7. The method for publicizing musical artists and promoting new musical works as claimed in claim 1 comprises the steps of:
generating a set of interactive instructions for the most-popular entry with the remote server; and
sending the set of interactive instructions and most-popular entry to the social networking link for each contestant account from the remote server.

8. The method for publicizing musical artists and promoting new musical works as claimed in claim 1 comprises the step of:
notifying the user accounts of the most-popular entry with the corresponding PC device.

9. The method for publicizing musical artists and promoting new musical works as claimed in claim 1 comprises the step of:
designating a plurality of remainder accounts from the plurality of user accounts with the remote server, wherein the remainder accounts are not included in the musical competition;
prompting each remainder account to upload a social networking link with the corresponding PC device; and
sharing the most-popular entry on the social networking link for at least one arbitrary account through the remote server, if the arbitrary account confirms to upload the social networking link, wherein the arbitrary account is any one of the plurality of remainder accounts.

10. A method for publicizing musical artists and promoting new musical works comprises the steps of:
(A) providing a plurality of user accounts managed by at least one remote server, wherein each user account is associated to a corresponding personal computing (PC) device;
(B) prompting each user account to enter a musical competition with the corresponding PC device;
(C) designating a plurality of contestant accounts from the plurality of user accounts with the remote sever, wherein each contestant account confirms to enter the musical competition in step (B);
(D) retrieving a social networking link and a musical entry for each contestant account through the corresponding PC device;
(E) compiling the musical entry for each contestant account into a plurality of anonymous musical entries with the remote server, wherein step (E) comprises the steps of:
providing the musical entry for each contestant account with a genuine title; and
replacing the genuine title of the musical entry for each contestant account with a randomly-generated title with the remote server during step (E);
(F) prompting each user account to listen and vote on each anonymous musical entry through the corresponding PC device;
(G) receiving a vote count for each anonymous musical entry with the remote server; and
(H) sharing a most-popular entry on the social networking link for each contestant account through the remote server, wherein the most-popular entry is one of the plurality of anonymous musical entries and received a largest vote count amongst the plurality of contestant accounts.

11. The method for publicizing musical artists and promoting new musical works as claimed in claim 10 comprises the steps of:
arranging the anonymous entries into a randomized playlist for each user account with the remote server; and
audibly and sequentially outputting each musical entry in accordance to the randomized playlist with the corresponding PC device of each user account.

12. The method for publicizing musical artists and promoting new musical works as claimed in claim 11 comprises the steps of:
providing a mandatory-listening time limit managed by the remote server;
audibly outputting a current entry within the randomized playlist with the corresponding PC device;
prompting each user account to play a subsequent entry within the randomized playlist with the corresponding PC device, if the current entry is audibly outputted for more than the mandatory-listening time limit; and
audibly outputting the subsequent entry within the randomized playlist with the corresponding PC device, if an arbitrary account confirms to play the subsequent entry, wherein the arbitrary account is any one of the plurality of user accounts.

13. The method for publicizing musical artists and promoting new musical works as claimed in claim 11 comprises the steps of:
providing a mandatory-listening time limit managed by the remote server;
audibly outputting a current entry within the randomized playlist with the corresponding PC device;
prompting each user account to play a preceding entry within the randomized playlist with the corresponding PC device, if the current entry is audibly outputted for more than the mandatory-listening time limit; and
audibly outputting the preceding entry within the randomized playlist with the corresponding PC device, if an arbitrary account confirms to play the previous entry, wherein the arbitrary account is any one of the plurality of user accounts.

14. The method for publicizing musical artists and promoting new musical works as claimed in claim 10 comprises the steps of:
providing a submission time period managed by the remote server;
notifying each contestant account of the submission time period with the corresponding PC device;
executing step (D) only during the submission time period; and
excluding at least one non-responsive account from the plurality of contestant accounts with the remote server, if the remote server does not receive the musical entry for the non-responsive account within the submission time period.

15. The method for publicizing musical artists and promoting new musical works as claimed in claim 10 comprises the steps of:
generating a set of interactive instructions for the most-popular entry with the remote server; and
sending the set of interactive instructions and most-popular entry to the social networking link for each contestant account from the remote server.

16. The method for publicizing musical artists and promoting new musical works as claimed in claim 10 comprises the step of:
notifying the user accounts of the most-popular entry with the corresponding PC device.

17. The method for publicizing musical artists and promoting new musical works as claimed in claim 10 comprises the step of:
designating a plurality of remainder accounts from the plurality of user accounts with the remote server, wherein the remainder accounts are not included in the musical competition;
prompting each remainder account to upload a social networking link with the corresponding PC device; and
sharing the most-popular entry on the social networking link for at least one arbitrary account through the remote server, if the arbitrary account confirms to upload the social networking link, wherein the arbitrary account is any one of the plurality of remainder accounts.
